(19) United States
(12) Patent Application Publication
(10) Pub. No.: US 2013/0120530 A1
(43) Pub. Date: May 16, 2013

(54) IMAGE PROCESSING APPARATUS AND METHOD AND PROGRAM

(71) Applicant: Tsuneo Hayashi, Chiba (JP)

(72) Inventor: Tsuneo Hayashi, Chiba (JP)

(21) Appl. No.: 13/811,752

(22) PCT Filed: Jul. 29, 2011
(86) PCT No.: PCT/JP2011/004318

§ 371 Date: Jan. 23, 2013

(30) Foreign Application Priority Data
Jul. 30, 2010 (JP) 2010-172503

(51) Int. Cl. H04N 13/00

(52) U.S. Cl. CPC H04N 13/0007
USPC 348/43

(57) ABSTRACT

A method, system, and computer-readable storage medium for processing images. In an exemplary embodiment, the system receives an image signal comprising a left-image signal representing a left image and a right-image signal representing a right image. The system generates a sum signal by combining the left-image signal and the right-image signal. The system also displays a sum image corresponding to the sum signal, where the displayed image includes a convergence point and a focus point.

### TECHNICAL FIELD

The present disclosure relates to image processing apparatuses and methods and programs and, in particular, an image processing apparatus and method and a program capable of more easily suppressing the occurrence of an error in the location of a congestion point, that is, convergence point, in 3D video.

### BACKGROUND ART

One characteristic of stereoscopic video obtained using a so-called single-lens stereoscopic 3D camera is that an in-focus object being a subject is oriented at a location on a displayed screen where the stereoscopic image is displayed. That is, when left eye video and right eye video that form stereoscopic video are displayed on a display screen, the same in-focus objects of the left and right video substantially match each other.

Therefore, for a display apparatus that allows a user to watch stereoscopic video using polarized glasses, shutter glasses, or other glasses, if the user watches video displayed on the display apparatus without the polarized glasses or other glasses, that video is seen as 2D (two-dimensional) video. And, if the user watches video displayed on the display apparatus through polarized glasses or other glasses, that video is seen as 3D (three-dimensional) video (for example, refer to Patent Literature 1). In this way, a display apparatus that can be used with polarized glasses or other glasses has a characteristic of compatibility between 2D video and 3D video.

### CITATION LIST

### Patent Literature

PTL 1: Japanese Unexamined Patent Application Publication No. 2010-62767

### SUMMARY OF INVENTION

Disclosed is a method for processing images on an electronic device. The method may including receiving an image signal comprising a left-image signal representing a left image and a right-image signal representing a right image. The method may further include generating a sum signal by combining the left-image signal and the right-image signal. The method may also include displaying a sum image corresponding to the sum signal, the displayed image including a convergence point and a focus point.

Also disclosed is an electronic device for processing images. The electronic device may receive an image signal comprising a left-image signal representing a left image and a right-image signal representing a right image. The electronic device may further generate a sum signal by combining the left-image signal and the right-image signal. The electronic device may also display a sum image corresponding to the sum signal, the displayed image including a convergence point and a focus point. Further disclosed is tangibly embodied non-transitory computer-readable storage medium including instructions that, when executed by a processor, perform a method for processing images on an electronic device. The method may including receiving an image signal comprising a left-image signal representing a left image and a right-image signal representing a right image. The method may further include generating a sum signal by combining the left-image signal and the right-image signal. The method may also include displaying a sum image corresponding to the sum signal, the displayed image including a convergence point and a focus point.

### Technical Problem

Incidentally, in the case where stereoscopic video is obtained by a single-lens stereoscopic 3D camera, a photographer makes either one of left eye video and right eye video be displayed on a viewer, and carries out lens adjustment on, for example, a focus, zoom, and iris while checking video for the single eye displayed on the viewer. In this way, when an image is obtained while video for a single eye is seen, a slight error in focusing may occur.

If a minute error in focus adjustment occurs in a single-lens stereoscopic 3D camera, when acquired stereoscopic video is displayed on a display apparatus, an error in the location of a congestion point for the left eye video and the right eye video from the display screen also occurs, and compatibility between 2D video and 3D video is lost.

In light of such circumstances, the present embodiment is directed to being capable of more easily suppressing an error in the location of a congestion point of 3D video.

### Advantageous Effects of Invention

In accordance with the first and second aspects of the present embodiment, the occurrence of an error in the location of a congestion point in 3D video can be suppressed more easily.

### BRIEF DESCRIPTION OF DRAWINGS

FIG. 1 illustrates a configuration example of one embodiment of an imaging apparatus to which the present embodiment is applied.

FIG. 2 is a flowchart for describing an imaging process.

FIG. 3 illustrates a configuration example of a signal reproducing apparatus.

FIG. 4 is a flowchart for describing a reproducing process.

FIG. 5 illustrates another configuration example of a signal reproducing apparatus.

FIG. 6 is a flowchart for describing a reproducing process.

FIG. 7 illustrates a configuration example of a signal reproducing unit.

FIG. 8 is a flowchart for describing an edit-point recording process.

FIG. 9 illustrates a configuration example of an imaging apparatus.

FIG. 10 is a flowchart for describing an imaging process.

FIG. 11 illustrates a configuration example of an imaging apparatus.

FIG. 12 is a flowchart for describing an imaging process.

FIG. 13 illustrates another configuration example of a signal reproducing apparatus.

FIG. 14 is a flowchart for describing a reproducing process.

FIG. 15 is a block diagram that illustrates a configuration example of a computer.

### DESCRIPTION OF EMBODIMENTS

Various embodiments are described below with reference to the drawings.

### First Embodiment

### Configuration of Imaging Apparatus

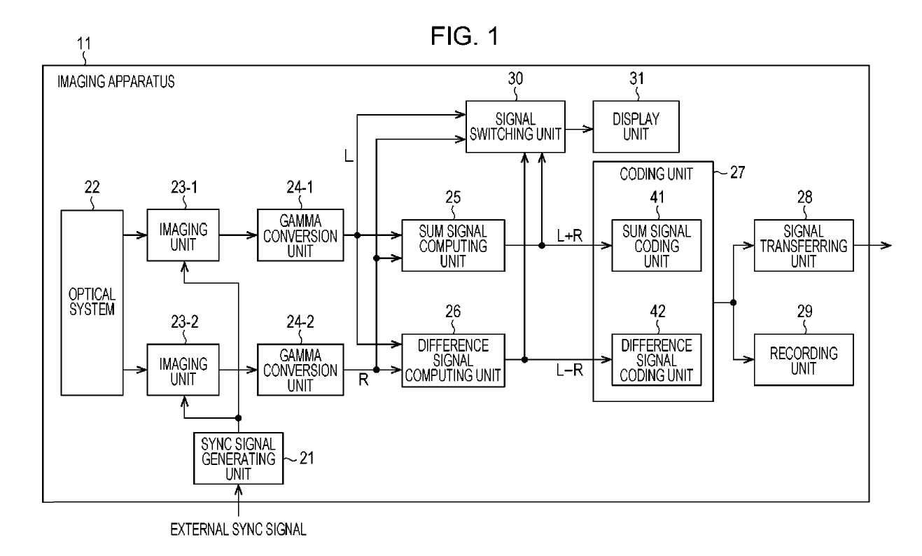

FIG. 1 illustrates a configuration example of one embodiment of an imaging apparatus.

An imaging apparatus 11 is a so-called single-lens stereoscopic 3D camera, and receives light from an object and acquires a stereoscopic image signal that includes an L signal being an image signal for a left eye and an R signal being an image signal for a right eye.

Here, in the case where a stereoscopic image is displayed on the basis of a stereoscopic image signal, an L signal for a left eye, that is, a left-image signal, is a signal for generating an image observed by the left eye of a user to be displayed, whereas an R signal for a right eye, that is, a right-image signal, is a signal for generating an image observed by the right eye of the user to be displayed. By way of example, the stereoscopic image signal may be a moving image signal.

The imaging apparatus 11 includes a synchronizing (sync) signal generating unit 21, an optical system 22, an imaging unit 23-1, an imaging unit 23-2, a gamma conversion unit 24-1, a gamma conversion unit 24-2, a sum signal computing unit 25, a difference signal computing unit 26, a coding unit 27, a signal transferring unit 28, a recording unit 29, a signal switching unit 30, and a display unit 31.

The sync signal generating unit 21 receives an externally supplied external sync signal of a specific frequency clock, generates a sync signal of the same frequency and phase as those of the supplied external sync signal, and supplies the generated sync signal to the imaging unit 23-1 and the imaging unit 23-2. If no external sync signal is supplied to the sync signal generating unit 21, the sync signal generating unit 21 may generate a sync signal of a frequency previously set in a so-called free-running manner.

The optical system 22 can include a plurality of lenses, for example, and guides light incident from an object to the imaging unit 23-1 and the imaging unit 23-2. For example, an entrance pupil of the optical system 22 is provided with a mirror or other elements for separating light incident from an object into two beams, and the two separated beams are guided to the imaging unit 23-1 and the imaging unit 23-2, respectively. More specifically, light incident on the entrance pupil of the optical system 22 is separated into two beams by two minors having different inclination directions arranged on an optical path of the light (for example, refer to Japanese Unexamined Patent Application Publication No. 2010-81580).

The imaging unit 23-1 and the imaging unit 23-2 generate an L signal and a R signal by photoelectrically converting light incident from the optical system 22 in synchronization with a sync signal supplied from the sync signal generating unit 21 and supply the L and R signals to the gamma conversion unit 24-1 and the gamma conversion unit 24-2.

The gamma conversion unit 24-1 and the gamma conversion unit 24-2 perform gamma conversion on an L signal and an R signal supplied from the imaging unit 23-1 and the imaging unit 23-2 and supply the signals to the sum signal computing unit 25, the difference signal computing unit 26, and the signal switching unit 30.

Note that hereinafter the imaging unit 23-1 and the imaging unit 23-2 are also referred to simply as the imaging unit 23 if it is not necessary to distinguish between them and the gamma conversion unit 24-1 and the gamma conversion unit 24-2 are also referred to simply as the gamma conversion unit 24 if it is not necessary to distinguish between them.

The sum signal computing unit 25 determines the sum of an L signal and an R signal supplied from the gamma conversion unit 24-1 and the gamma conversion unit 24-2 and supplies the resultant sum signal to the coding unit 27 and the signal switching unit 30. The difference signal computing unit 26 determines the difference between an L signal and an R signal supplied from the gamma conversion unit 24-1 and the gamma conversion unit 24-2 and supplies the resultant difference signal to the coding unit 27 and the signal switching unit 30.

The coding unit 27 includes a sum signal coding unit 41 that codes a sum signal from the sum signal computing unit 25 and a difference signal coding unit 42 that codes a difference signal from the difference signal computing unit 26. The coding unit 27 supplies the sum signal and difference signal acquired by coding to the recording unit 29 and the signal transferring unit 28.

The signal transferring unit 28 transfers (sends) a sum signal and a difference signal supplied from the coding unit 27 to an apparatus (not illustrated) connected over a communication network, such as the Internet, or a cable. And, the recording unit 29 includes a hard disk or other elements and records a sum signal and a difference signal supplied from the coding unit 27.

The signal switching unit 30 supplies the display unit 31 with any one of an L signal and an R signal supplied from the gamma conversion unit 24, a sum signal supplied from the sum signal computing unit 25, and a difference signal supplied from the difference signal computing unit 26, and the display unit 31 displays an image corresponding to the respective signal supplied. In other words, the display unit 31 may display a left image corresponding to the left-image signal if the left-image signal is supplied, a right image corresponding to the right-image signal if the right-image signal is supplied, a sum image corresponding to the sum signal if the sum signal is supplied, a difference image corresponding to the difference signal if the difference signal is supplied, or any combination of such images.

### Description of Imaging Process

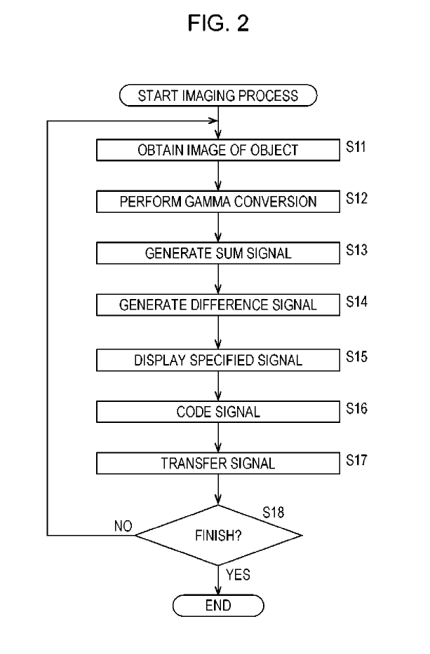

Incidentally, when a user operates the imaging apparatus 11 and provides an instruction to start obtaining an image of an object, the imaging apparatus 11 starts an imaging process, obtains the image of the object, and generates a stereoscopic image signal. The imaging process performed by the imaging apparatus 11 is described below with reference to the flowchart of FIG. 2.

At step S11, the imaging unit 23 obtains an image of an object. That is, the optical system 22 collects light incident from an object, separates it into two beams, and causes them to be incident on the imaging unit 23-1 and the imaging unit 23-2.

Each of the imaging unit 23-1 and the imaging unit 23-2 obtains an image of an object by photoelectrically converting light incident from the optical system 22 in synchronization with a sync signal supplied from the sync signal generating unit 21. By virtue of the sync signal, images of the same frame of an L signal and an R signal are always obtained at the same time. The imaging unit 23-1 and the imaging unit 23-2 supply the L signal and R signal acquired by the photoelectrical conversion to the gamma conversion unit 24-1 and the gamma conversion unit 24-2.

At step S12, the gamma conversion unit 24-1 and the gamma conversion unit 24-2 perform gamma conversion on an L signal and an R signal supplied from the imaging unit 23-1 and the imaging unit 23-2. With this, the L signal and R signal are gamma-corrected. The gamma conversion unit 24-1 and the gamma conversion unit 24-2 supply the L signal and R signal subjected to the gamma conversion to the sum signal computing unit 25, the difference signal computing unit 26, and the signal switching unit 30.

For example, for gamma conversion, when an input value, that is, the value of an L signal or an R signal before gamma conversion is x and an output value, that is, the value of an L signal or an R signal after gamma conversion is y, y=x^{(1/2.2)}. Accordingly, a curve that indicates an input-output characteristic of gamma conversion when the horizontal axis represents an input value and the vertical axis represents an output value is a curve that is bowed upward in the vertical axis (convex upward). The exponent in gamma conversion is not limited to (½.2), and it may be another value.

Note that, in the gamma conversion unit 24, in addition to gamma conversion, another correction process for improving the image quality, such as defect correction, white balance adjustment, or shading adjustment, may be performed on an L signal and an R signal.

At step S13, the sum signal computing unit 25 generates a sum signal by determining the sum of an L signal and an R signal supplied from the gamma conversion unit 24 and supplies it to the sum signal coding unit 41 or the signal switching unit 30. That is, as for an L signal and an R signal of a specific frame, the sum signal computing unit 25 determines the sum of the pixel value of a pixel of an image corresponding to the L signal (hereinafter also referred to as L image) and the pixel value of a pixel of an image corresponding to the R signal (hereinafter also referred to as R image) that is in the same location as the pixel of the L image and sets the determined sum as the pixel value of the pixel of the image corresponding to the sum signal, that is, sum image.

Note that, although the pixel value of each pixel of an image corresponding to a sum signal is described as the sum of the pixel value of a pixel of an L image and the pixel value of a pixel of an R image, the pixels being in the same location in the same frame, the pixel value of the pixel of an image corresponding to a sum signal may be a value acquired by normalization of the sum of the pixel values of pixels in the same location of the L image and R image. When the pixel value of a sum signal is the sum of a pixel value of an L signal and that of an R signal and also when the pixel value of a sum signal is a value acquired by normalization of the sum of a pixel value of an L signal and that of an R signal (e.g., average value), the result is that the image corresponding to the sum signal is an image in which an L image and an R image are overlaid with each other. In other words, only dynamic ranges of the respective images are different.

At step S14, the difference signal computing unit 26 generates a difference signal by determining the difference between an L signal and an R signal supplied from the gamma conversion unit 24 and supplies it to the difference signal coding unit 42 and the signal switching unit 30. That is, for an L signal and an R signal of a specific frame, the difference signal computing unit 26 subtracts, from the pixel value of a pixel in the L image, the pixel value of a pixel of the R image that is in the same location as the pixel of the L image and sets the resultant difference of the pixel values as the pixel value of the corresponding pixel of the difference image.

As in the case of a sum signal, for a difference signal, the pixel value of a pixel in the difference image, may be a value in which the difference between an L signal and an R signal is normalized. And, if a coder at a subsequent step (difference signal coding unit 42) cannot take a negative value as its input, a preset offset value may be added so as to prevent a difference signal from having a negative value.

At step S15, the signal switching unit 30 supplies the display unit 31 with a user-specified signal among an L signal and an R signal from the gamma conversion unit 24, a sum signal from the sum signal computing unit 25, and a difference signal from the difference signal computing unit 26, and the display unit 31 displays an image corresponding to the respective signal supplied. In other words, the display unit 31 may display a left image corresponding to the left-image signal if the left-image signal is supplied, a right image corresponding to the right-image signal if the right-image signal is supplied, a sum image corresponding to the sum signal if the sum signal is supplied, a difference image corresponding to the difference signal if the difference signal is supplied, or any combination of such images.

With this, a user can display an image corresponding to any one signal of an L signal, R signal, sum signal, and difference signal on the display unit 31 when operating the imaging apparatus 11 and obtaining an image of an object. Accordingly, the user can switch a displayed image to a desired one and obtain an image of the object while seeing the displayed image on the display unit 31.

For example, when an image corresponding to a sum signal is displayed on the display unit 31, because the image corresponding to the sum signal may be an image in which an L image and an R image are overlaid with each other, a user can obtain an image while checking to determine that no error occurs between the L image for the left eye and the R image for the right eye.

One characteristic of the imaging apparatus 11 being a single-lens stereoscopic 3D camera is that a focus position, that is, focus point, of the optical system 22 and a congestion point coincide with each other. Therefore, lens adjustment in the optical system 22 by a user seeing an image corresponding to a sum signal displayed on the display unit 31 such that a congestion point is in a location on a display screen of the display unit 31, in other words, such that the same object contained in the L image and in the R image are overlaid with each other in an image corresponding to a sum signal corresponds to setting a focus position with high precision.

Accordingly, a user can reliably put an object of interest into focus by an easy operation of performing lens adjustment of the optical system 22 such that left and right images of the object of interest coincide with each other while seeing an image corresponding to a sum signal displayed on the display unit 31. Because the object of interest can be focused with high precision by an easy operation, the imaging apparatus 11 can orient the object of interest on a display screen when the acquired stereoscopic image is reproduced. In other words, the occurrence of an error in the location of a congestion point of a stereoscopic image can be suppressed more easily.

In this way, displaying an image corresponding to a sum signal on the display unit 31 enables a user to obtain a stereoscopic image while checking for not only a focus position but also for an error in the location of a congestion point for an L image and an R image.

And, for example, when an image displayed on the display unit 31 is switched to an image corresponding to a L signal or an R signal, a user can obtain an image of a stereoscopic image while conducting lens operation of focusing video for a single eye and while seeing the L image or the R image, as in a traditional case. Additionally, displaying on the display unit 31 is switched to an image corresponding to the difference signal enables a user to make only a component of an error in the location of a congestion point, between an L image and an R image be displayed and operate a lens of the optical system 22 so as to eliminate an error in the location of a congestion point between the left and right images with high precision.

At step S15, an image corresponding to a user-specified signal is displayed on the display unit 31. At step S16, the coding unit 27 codes a sum signal and a difference signal and supplies them to the signal transferring unit 28 and the recording unit 29.

That is, the sum signal coding unit 41 codes a sum signal supplied from the sum signal computing unit 25 by a specific coding method, whereas the difference signal coding unit 42 codes a difference signal supplied from the difference signal computing unit 26 by a specific coding method.

Here, a coding method used in coding a sum signal and a difference signal can be, for example, moving picture experts group (MPEG), joint photographic experts group (JPEG) 2000, or advanced video coding (AVC). For example, if a method, such as JPEG 2000, that employs wavelet transformation, that divides a single image into a plurality of images having different resolutions, and that performs progressive coding is used as the coding method, an image having a necessary resolution can be acquired with a small amount of processing at a destination to which a sum signal and a difference signal are transferred.

At step S17, the signal transferring unit 28 transfers a sum signal and a difference signal supplied from the coding unit 27 to another apparatus. And, the recording unit 29 records the sum signal and the difference signal supplied from the coding unit 27.

At step S18, the imaging apparatus 11 determines whether obtainment of an image of the object is to finish. For example, when a user provides an instruction to complete obtaining an image of the object, the imaging apparatus 11 determines that it is to finish.

At step S18, when the obtainment of an image is determined not to finish, the processing returns to step S11 and the above-described processing is repeated. In contrast to this, at step S18, when the obtainment of an image is determined to finish, the units of the imaging apparatus 11 stop their running processing, and the imaging process finishes.

In this manner, during obtaining an image of an object, the imaging apparatus 11 generates, from an L signal and an R signal acquired by the obtainment of the image of the object, a sum signal of them and displays an image corresponding to the sum signal. In this way, displaying the image corresponding to the sum signal during obtaining the image of the object enables a user to obtain the image of the object while checking for an error in the location of a congestion point between left and right images, thus allowing focus adjustment to be carried out more easily and with high precision. As a result, the occurrence of an error in the location of a congestion point of a stereoscopic image acquired by obtainment of an image can be suppressed, and compatibility between 2D video and 3D video can be provided to the stereoscopic image.

Note that, although in the foregoing a single-lens stereoscopic 3D camera used as an example of the imaging apparatus 11 is described, the present embodiment is also applicable to a twin-lens 3D camera in which a congestion point of left eye video and right eye video and a focus position match each other at a specific location in a depth direction on a display screen. A twin-lens 3D camera independently carries out adjustment of a congestion point and adjustment of a focus position; if video in which left eye video and right eye video are overlaid with each other is made to be displayed and a photographer operates a lens, compatibility between 2D video and 3D video can be provided to a stereoscopic image.

### Configuration of Signal Reproducing Apparatus

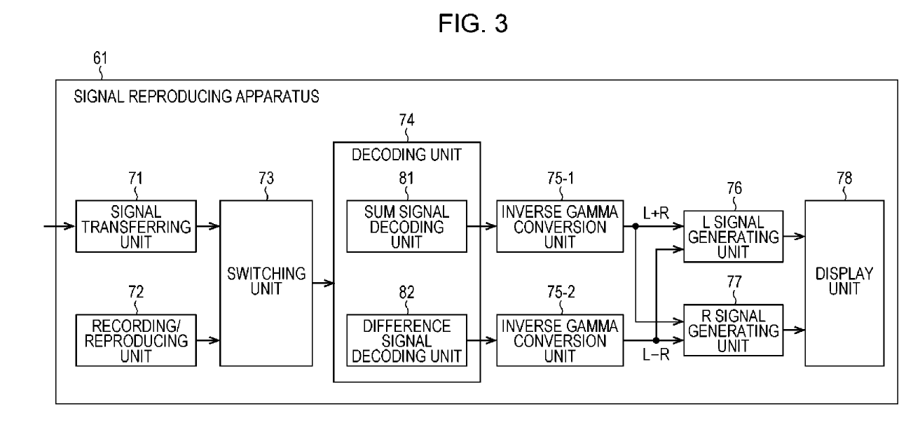

And, a sum signal and a difference signal output from the imaging apparatus 11 in FIG. 1 can be received by a signal reproducing apparatus 61 illustrated in FIG. 3 and re-produced, for example.

The signal reproducing apparatus 61 illustrated in FIG. 3 includes a signal transferring unit 71, a recording/reproducing unit 72, a switching unit 73, a decoding unit 74, an inverse gamma conversion unit 75-1, an inverse gamma conversion unit 75-2, an L signal generating unit 76, an R signal generating unit 77, and a display unit 78.

The signal transferring unit 71 receives a sum signal and a difference signal transmitted from the imaging apparatus 11 and supplies them to the switching unit 73. Note that a sum signal and a difference signal received by the signal transferring unit 71 may be supplied to the recording/reproducing unit 72 and recorded.

The recording/reproducing unit 72 supplies a recorded sum signal and difference signal to the switching unit 73. The switching unit 73 supplies the sum signal and difference signal supplied from either one of the signal transferring unit 71 and the recording/reproducing unit 72 to the decoding unit 74.

The decoding unit 74 includes a sum signal decoding unit 81 that decodes a sum signal from the switching unit 73 and a difference signal decoding unit 82 that decodes a difference signal from the switching unit 73 and supplies the decoded sum signal and difference signal to the inverse gamma conversion unit 75-1 and the inverse gamma conversion unit 75-2. Here, a decoding method used in the decoding unit 74 corresponds to a coding method used in the imaging apparatus 11.

The inverse gamma conversion unit 75-1 and the inverse gamma conversion unit 75-2 perform inverse gamma conversion on a sum signal and a difference signal supplied from the decoding unit 74 and supply the resultant signals to the L signal generating unit 76 and the R signal generating unit 77. Note that hereinafter the inverse gamma conversion unit 75-1 and the inverse gamma conversion unit 75-2 are also referred to simply as the inverse gamma conversion unit 75 if it is not necessary to distinguish between them.

The L signal generating unit 76 generates an L signal from a sum signal and a difference signal supplied from the inverse gamma conversion unit 75-1 and the inverse gamma conversion unit 75-2 and supplies it to the display unit 78. The R signal generating unit 77 generates an R signal from a sum signal and a difference signal supplied from the inverse gamma conversion unit 75-1 and the inverse gamma conversion unit 75-2 and supplies it to the display unit 78.

The display unit 78 stereoscopically displays an image corresponding to the L signal supplied from the L signal generating unit 76 and an R signal supplied from the R signal generating unit 77 by a specific display method that allows a user to watch a stereoscopic image using, for example, polarized glasses. That is, an L image and an R image are displayed such that the R image is observed by the right eye of a user who wears polarized glasses or other glasses and the L image is observed by the left eye.

### Description of Reproducing Process

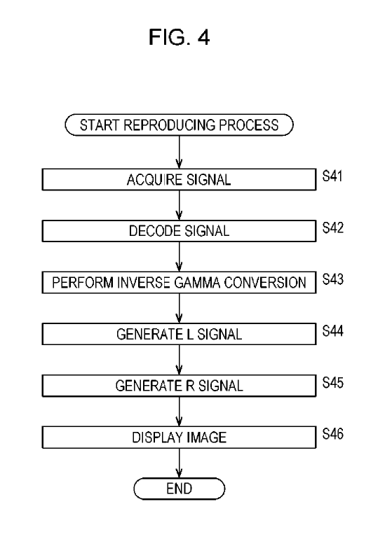

When a user provides an instruction to display a stereoscopic image, the signal re-producing apparatus 61 illustrated in FIG. 3 performs a reproducing process in response to the instruction and displays the stereoscopic image. The reproducing process performed by the signal reproducing apparatus 61 is described below with reference to the flowchart of FIG. 4.

At step S41, the switching unit 73 acquires a stereoscopic image signal of a stereoscopic image that a user has provided an instruction to reproduce. That is, the switching unit 73 acquires a sum signal and a difference signal that form a user-specified stereoscopic image signal and supplies them to the decoding unit 74.

At step S42, the decoding unit 74 decodes a sum signal and a difference signal supplied from the switching unit 73 and supplies them to the inverse gamma conversion unit 75. Specifically, the sum signal is decoded by the sum signal decoding unit 81 and supplied to the inverse gamma conversion unit 75-1, whereas the difference signal is decoded by the difference signal decoding unit 82 and supplied to the inverse gamma conversion unit 75-2.

At step S43, the inverse gamma conversion unit 75-1 and the inverse gamma conversion unit 75-2 perform inverse gamma conversion on a sum signal and a difference signal supplied from the sum signal decoding unit 81 and the difference signal decoding unit 82 and supply the resultant signals to the L signal generating unit 76 and the R signal generating unit 77.

For example, for inverse gamma conversion, when an input value, that is, the value of a sum signal or a difference signal before inverse gamma conversion is x and an output value, that is, the value of a sum signal or a difference signal after inverse gamma conversion is y, y=x^{(2.2)}. Accordingly, a curve that indicates an input-output characteristic of inverse gamma conversion when the horizontal axis represents an input value and the vertical axis represents an output value is a curve that is bowed downward in the vertical axis (convex downward). The exponent in inverse gamma conversion is not limited to (2.2), and it may be another value.

At step S44, the L signal generating unit 76 generates an L signal by dividing the sum of a sum signal and a difference signal supplied from the inverse gamma conversion unit 75 by 2 and supplies the L signal to the display unit 78. And, at step S45, the R signal generating unit 77 generates an R signal by dividing the difference between a sum signal and a difference signal supplied from the inverse gamma conversion unit 75 by 2 and supplies the R signal to the display unit 78. That is, the difference signal is subtracted from the sum signal and divided by 2.

At step S46, the display unit 78 displays a stereoscopic image corresponding to an L signal and an R signal supplied from the L signal generating unit 76 and the R signal generating unit 77, and the reproducing process finishes. Note that a method of displaying a stereoscopic image used in the display unit 78 can be any method, such as a polarized-glasses method, a time-division shutter method, or a lenticular system.

In this manner, the signal reproducing apparatus 61 decodes a coded sum signal and difference signal, extracts an L signal and an R signal by computation, and displays a stereoscopic image corresponding to the respective signal. Note that, also in the signal reproducing apparatus 61, displaying may be switched so as to display any one of a stereoscopic image, an L image, an R image, an image of a sum signal, and an image of a difference signal.

### Second Embodiment

### Configuration of Signal Reproducing Apparatus

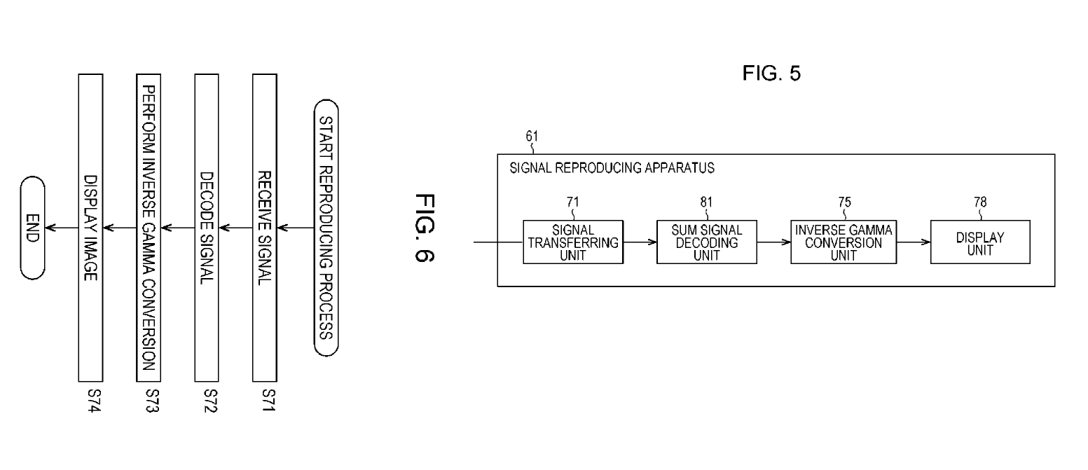

And, for example, when the imaging apparatus 11 is remotely controlled or in another case, an image of a sum signal may be displayed in the signal reproducing apparatus 61 for focus operation. In such a case, the signal reproducing apparatus 61 can be configured as illustrated in FIG. 5, for example. Note that in FIG. 5 the same reference numerals are used as in FIG. 3 for corresponding portions and the description thereof is omitted as appropriate.

The signal reproducing apparatus 61 in FIG. 5 includes a signal transferring unit 71, a sum signal decoding unit 81, an inverse gamma conversion unit 75, and a display unit 78. For this signal reproducing apparatus 61, after a sum signal received by the signal transferring unit 71 is decoded by the sum signal decoding unit 81, the decoded signal is subjected to inverse gamma conversion by the inverse gamma conversion unit 75 and a resultant image corresponding to the signal is displayed on the display unit 78.

### Description of Reproducing Process

Next, a reproducing process performed by the signal reproducing apparatus 61 in FIG.

5 is described with reference to the flowchart of FIG. 6.

At step S71, the signal transferring unit 71 receives a sum signal transmitted from the imaging apparatus 11 and supplies it to the sum signal decoding unit 81.

At step S72, the sum signal decoding unit 81 decodes a sum signal supplied from the signal transferring unit 71 and supplies it to the inverse gamma conversion unit 75.

For example, when a sum signal has been subjected to progressive coding, the sum signal decoding unit 81 carries out decoding using necessary data of the sum signal so as to acquire an image having user-specified resolution. Specifically, a sum signal is decoded using, of a sum signal subjected to progressive coding, data of layers, from data of the lowest layer used in acquiring an image having the lowest resolution to data of a layer used in acquiring an image having specified resolution.

In this way, if only a needed resolution component of a sum signal is decoded, the amount of processing from reception of the sum signal to displaying an image corresponding to the sum signal can be reduced and an image corresponding to the sum signal can be displayed more quickly.

Note that if resolution (layer) of a sum signal is specified by a user, the signal transferring unit 71 may request coded data of the sum signal from the lowest layer to a specified layer from the imaging apparatus 11 and receive only data of the sum signal necessary for decoding.

At step S73, the inverse gamma conversion unit 75 performs inverse gamma conversion on a sum signal supplied from the sum signal decoding unit 81 and supplies it to the display unit 78. Note that, in the inverse gamma conversion at step S73, substantially the same processing is performed as at step S43 in FIG. 4. Then, at step S74, the display unit 78 displays an image corresponding to the sum signal supplied from the inverse gamma conversion unit 75, and the reproducing process finishes.

A user conducts remote control or other operations of the imaging apparatus 11 while checking an image corresponding to a sum signal displayed on the display unit 78. Also in this case, as in the case of the imaging process described with reference to FIG. 2, during obtaining an image of an object, the user can obtain the image of the object while seeing the displayed image corresponding to the sum signal and checking for an error in the location of a congestion point between the left and right images, and the occurrence of an error in focusing can be more easily suppressed.

The signal reproducing apparatus 61 in FIG. 5 is configured to decode and display only an image corresponding to a sum signal. Thus, with this signal reproducing apparatus 61, size reduction, cost reduction, power saving, and speed enhancement of processing of the apparatus can be achieved.

### Third Embodiment

### Configuration of Signal Reproducing Unit

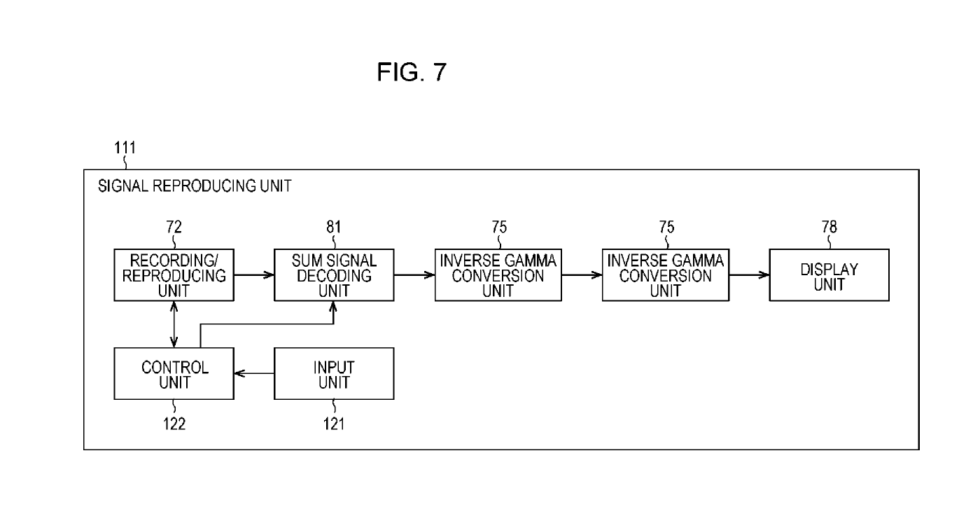

And, one possible example of an apparatus that employs a sum signal and a difference signal coded by the imaging apparatus 11 can be an editing apparatus for editing a stereoscopic image (i.e., moving image) that is formed of a sum signal and a difference signal. FIG. 7 illustrates a configuration example of a signal reproducing unit incorporated in such an editing apparatus.

A signal reproducing unit 111 includes an input unit 121, a control unit 122, a recording/reproducing unit 72, a sum signal decoding unit 81, an inverse gamma conversion unit 75, and a display unit 78. Note that in FIG. 7 the same reference numerals are used as in FIG. 3 for corresponding portions and the description thereof is omitted as appropriate.

When being operated by a user, the input unit 121 supplies a signal corresponding to that operation to the control unit 122. In response to the signal from the input unit 121, the control unit 122 can instruct the sum signal decoding unit 81 to decode a sum signal and edit a sum signal and a difference signal recorded in the recording/re-producing unit 72. The recording/reproducing unit 72 records a sum signal and a difference signal acquired by obtainment of an image of an object by the imaging apparatus 11.

### Description of Edit-point Recording Process

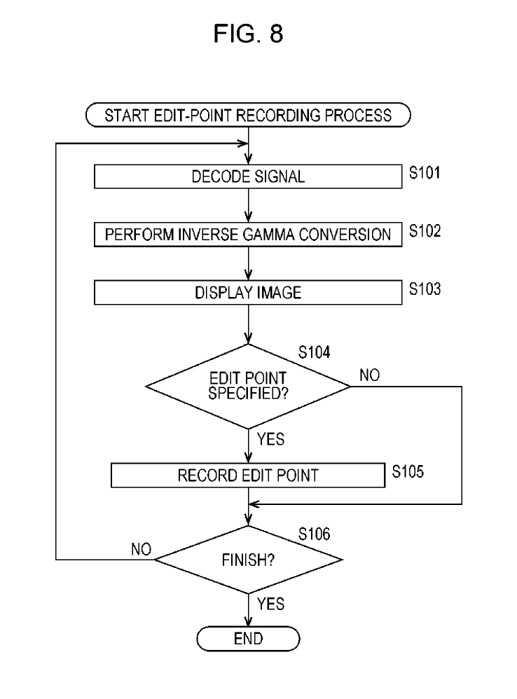

When a user operates the signal reproducing unit 111 described above and provides an instruction to edit a sum signal and a difference signal recorded in the recording/reproducing unit 72, the signal reproducing unit 111 starts an edit-point recording process. The edit-point recording process performed by the signal reproducing unit 111 is described below with reference to the flowchart of FIG. 8.

At step S101, the sum signal decoding unit 81 acquires a sum signal of a stereoscopic image to be displayed from the recording/reproducing unit 72 and decodes it. That is, when a user operates the input unit 121, specifies a stereoscopic image, and provides an instruction to start editing the stereoscopic image, the control unit 122 instructs the sum signal decoding unit 81 to decode the sum signal forming the user-specified stereoscopic image. Then, the sum signal decoding unit 81 decodes the sum signal in accordance with the instruction from the control unit 122 and supplies it to the inverse gamma conversion unit 75. Here, for example, if the sum signal has been subjected to progressive coding and resolution of an image corresponding to the sum signal to be displayed is specified by a user, decoding of the sum signal with needed resolution is conducted.

At step S102, the inverse gamma conversion unit 75 performs inverse gamma conversion on a sum signal from the sum signal decoding unit 81 and supplies it to the display unit 78. Note that, in the inverse gamma conversion at step S102, substantially the same processing is performed as at step S43 in FIG. 4. Then, at step S103, the display unit 78 displays an image corresponding to the sum signal on the basis of the sum signal supplied from the inverse gamma conversion unit 75.

In this manner, when an image corresponding to a sum signal is displayed, a user operates the input unit 121 as appropriate, and specifies an edit point of a stereoscopic image, that is, a starting point and an end point of a scene that the user aims to cut while, for example, fast-forwarding or fast-reproducing the displayed image.

At step S104, the control unit 122 determines whether an edit point has been specified by a user. When, at step S104, an edit point is determined to have been specified, at step S105 the control unit 122 records the specified edit point of a stereoscopic image in the recording/reproducing unit 72 on the basis of the signal from the input unit 121. That is, the reproduction time of each of a starting point and an end point of the stereoscopic image specified as an edit point is recorded.

When, at step S105, an edit point is recorded or when, at step S104, an edit point is determined not to have been specified, at step S106 the control unit 122 determines whether the process is to finish. For example, when a user specifies all edit points of a stereoscopic image and provides an instruction to end editing, it is determined that the process is to finish.

When, at step S106, it is determined that the process is not to finish, the processing returns to step S101, and the above-described processing is repeated. That is, a signal of a next frame of a stereoscopic image is decoded and displayed, and an edit point is recorded in response to an operation of a user.

In contrast to this, when, at step S106, it is determined that the process is to finish, the edit-point recording process finishes.

And, after the completion of an edit-point recording process, the signal reproducing unit 111 edits a stereoscopic image on the basis of an edit point recorded in the recording/reproducing unit 72. That is, at the time of the completion of the edit-point recording process, only an edit point that identifies each scene to be cut from a stereoscopic image, and the stereoscopic image is not actually edited.

So, after the execution of an edit-point recording process, on the basis of a user-specified edit point, the signal reproducing unit 111 cuts a scene identified by that edit point from each of a sum signal and a difference signal that form a stereoscopic image recorded in the recording/reproducing unit 72 and edits them. That is, user-specified scenes in a sum signal are cut and combined to form into a new sum signal, whereas user-specified scenes in a difference signal are cut and combined to form into a new difference signal. Then, a moving image corresponding to the new sum signal and difference signal acquired in this way is the stereoscopic image after editing.

In the above-described way, the signal reproducing unit 111 reads and decodes, out of a sum signal and a difference signal that form a recorded stereoscopic image, only the sum signal, displays it, and records an edit point in response to an operation of the user. Then, the signal reproducing unit 111 records all edit points and, after the completion of an edit-point recording process, edits the stereoscopic image on the basis of a recorded edit point independently of an operation of the user.

In this way, because only a sum signal is decoded in the signal reproducing unit 111 at the time of specifying an edit point, an image necessary for editing can be displayed quickly with a smaller amount of processing, in comparison to when both a sum signal and a difference signal are decoded for displaying a stereoscopic image. In particular, if a sum signal has been subjected to progressive coding, because merely acquisition of an image with necessary resolution is required and it is not necessary to decode a sum signal of each of all layers, an image corresponding to the sum signal can be quickly displayed with a smaller amount of processing.

And, an actual editing process is performed by the signal reproducing unit 111 after an edit point is specified and an edit-point recording process finishes. Thus, a user does not have to do a particular operation and the time required for editing work can be more shortened.

Note that because an object in an L image and an object in an R image are displayed in an image corresponding to a sum signal, a user can select a scene to be cut while seeing the image corresponding to the sum signal and checking whether no error in the location of a congestion point occurs between the L image for the left eye and the R image for the right eye.

For example, for an editing system based on a calculator, such as a personal computer, at the time of editing a stereoscopic image, if both an L image and an R image are decoded for displaying the stereoscopic image, throughput of the calculator may be insufficient. If so, decoding and displaying a stereoscopic image in an actual time, that is, the same time as that required for obtainment of the image may be impossible.

In contrast to this, the signal reproducing unit 111 decodes and displays only an image corresponding to a sum signal, so the throughput required for decoding is half that when both an L image and an R image are decoded, as in a traditional case. Thus, a sum signal can be decoded and an image corresponding to the sum signal can be displayed with higher speed.

Additionally, the signal reproducing unit 111 is configured to decode and display only a sum signal. Thus, with this signal reproducing apparatus 111, size reduction, cost reduction, power saving, and speed enhancement of processing of the apparatus can be achieved.

### Fourth Embodiment

### Configuration of Imaging Apparatus

And, although an example in which two imaging units 23 obtain an L signal and an R signal has been described with reference to FIG. 1, a single imaging unit may obtain an L image and an R image by dividing an obtained image of an object.

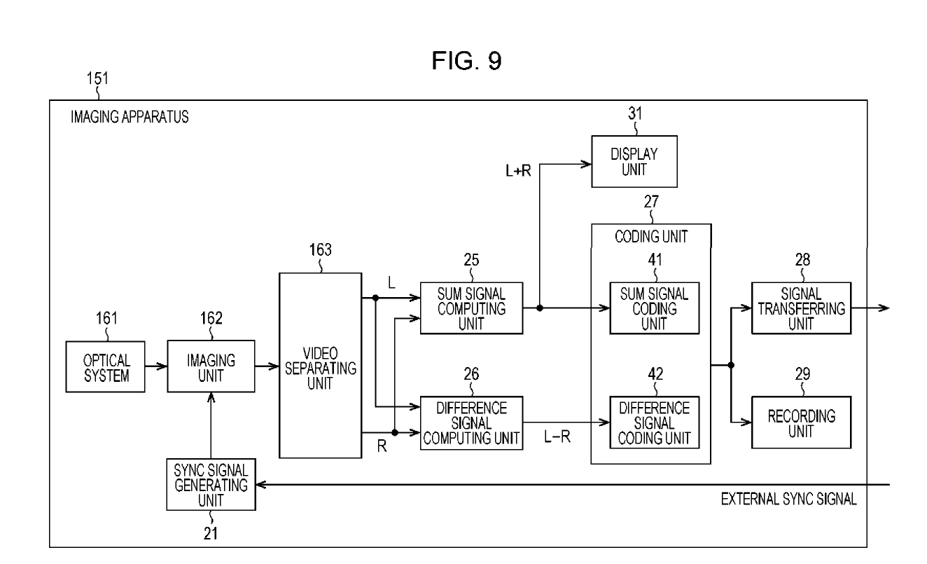

In such a case, an imaging apparatus can be configured as illustrated in FIG. 9, for example. Note that in FIG. 9 the same reference numerals are used as in FIG. 1 for corresponding portions and the description thereof is omitted as appropriate.

An imaging apparatus 151 in FIG. 9 include a sync signal generating unit 21, an optical system 161, an imaging unit 162, a video separating unit 163, a sum signal computing unit 25, a difference signal computing unit 26, a coding unit 27, a signal transferring unit 28, a recording unit 29, and a display unit 31.

The optical system 161 can include a lens and a polarizing element, for example, and guides light from an object to the imaging unit 162. The imaging unit 162 obtains an L image and an R image at different observation positions (view positions) of the object by photoelectrically converting light incident from the optical system 161.

More specifically, pixels of a light sensing surface of the imaging unit 162 include pixels on which light forming an L image, out of light from an object, is incident and pixels on which light forming an R image is incident. For example, a polarizing element forming the optical system 161 separates light from an object into light forming an L image and light forming an R image by extracting only light in a particular polarizing direction and makes the light be incident on corresponding pixels the light sensing surface of the imaging unit 162.

That is, a polarizing element at the position of an entrance pupil of the optical system 161 and a polarizing element in each pixel on the light sensing surface of the imaging unit 162 enable only either one of light forming an L image and light forming an R image to be incident on each pixel of the imaging unit 162. Accordingly, a single image acquired by obtainment of an image by the imaging unit 162 results in generation of a signal having an L image component and an R image component. A signal generated by the imaging unit 162 is supplied to the video separating unit 163.

The video separating unit 163 separates the signal from the imaging unit 162 into an

L signal and an R signal by extracting an L signal component and an R signal component from the signal supplied from the imaging unit 162 and supplies the L and R signals to the sum signal computing unit 25 and the difference signal computing unit 26.

Note that in the imaging apparatus 151 only an image corresponding to a sum signal formed by an L signal and an R signal is displayed on the display unit 31. And, the imaging apparatus 151 may include a gamma conversion unit that performs gamma conversion on an L signal and an R signal.

### Description of Imaging Process

Next, an operation of the imaging apparatus 151 is described.

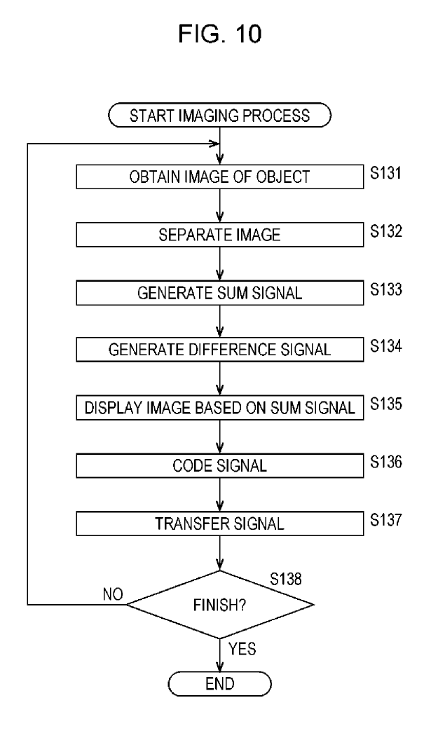

When a user operates the imaging apparatus 151 and provides an instruction to start obtaining an image of an object, the imaging apparatus 151 starts an imaging process, obtains the image of the object, and generates a stereoscopic image signal. The imaging process performed by the imaging apparatus 151 is described below with reference to the flowchart of FIG. 10.

At step S131, the imaging unit 162 generates a signal corresponding to the image of an object. That is, the optical system 161 separates light from an object into light forming an L signal and light forming an R signal and makes the separated light incident on corresponding pixels of the imaging unit 162. The imaging unit 162 generates the signal corresponding to the image of the object by photoelectrically converting light incident from the optical system 161 in synchronization with a sync signal supplied from the sync signal generating unit 21 and supplies the resultant signal to the video separating unit 163.

At step S132, the video separating unit 163 separates an L signal component and an R signal component of a signal supplied from the imaging unit 162 and performs a correction process as needed, thereby generating an L signal and an R signal and supplying the L and R signals to the sum signal computing unit 25 and the difference signal computing unit 26.

At step S133, the sum signal computing unit 25 generates a sum signal from an L signal and an R signal supplied from the video separating unit 163 and supplies the sum signal to the coding unit 27 and the display unit 31. Then, at step S134, the difference signal computing unit 26 generates a difference signal from an L signal and an R signal supplied from the video separating unit 163 and supplies the difference signal to the coding unit 27.

At step S135, the display unit 31 displays an image corresponding to a sum signal supplied from the sum signal computing unit 25. Additionally, at step S136, the coding unit 27 codes a sum signal and a difference signal supplied from the sum signal computing unit 25 and the difference signal computing unit 26 and supplies the coded signals to the signal transferring unit 28 and the recording unit 29.

After that, the processing at step S137 and step S138 is performed, and the imaging process finishes. This processing is substantially the same as that at step S17 and step S18 in FIG. 2, so the description thereof is omitted.

In this manner, the imaging apparatus 151 generates an L signal and an R signal from a signal corresponding to an image obtained by the single imaging unit 162.

Note that, although the optical system 161 described above separates light forming an L image and light forming an R image using a polarizing element, the right half and the left half of a beam incident on the entrance pupil of the optical system 161 may be made to be alternately incident on the imaging unit 162 in a time division manner using a shutter (for example, refer to Japanese Unexamined Patent Application Publication No. 2001-61165). In such a case, an L signal and an R signal are alternately generated by the imaging unit 162.

### Fifth Embodiment

### Configuration of Imaging Apparatus

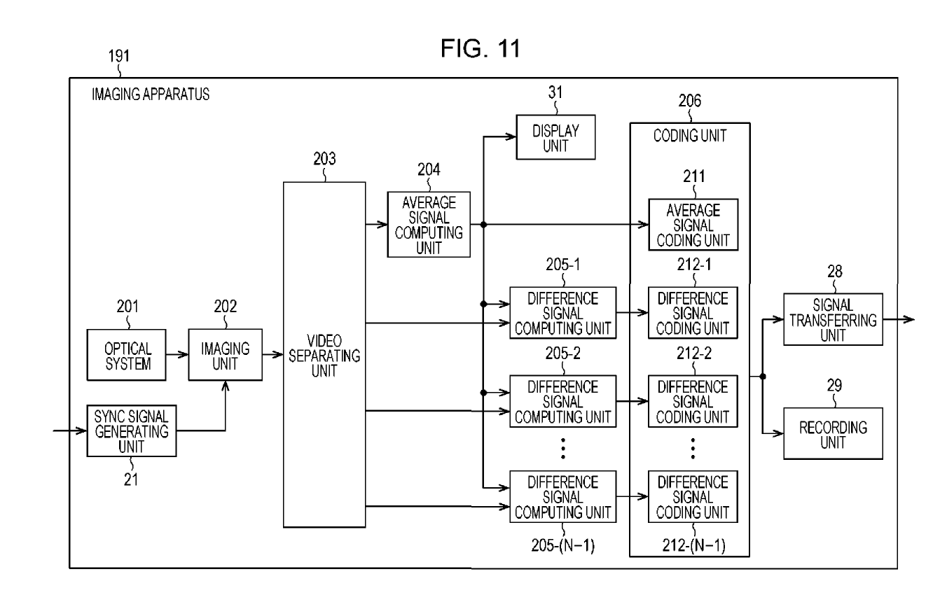

And, with reference to FIG. 1, an example is described in which a stereoscopic image formed of an L image and an R image is obtained. However, a multi-view image in which a stereoscopic image having a different view is displayed depending on a location where a user watches it may be obtained. In such a case, an example imaging apparatus is configured as illustrated in FIG. 11.

For example, an imaging apparatus 191 in FIG. 11 can be a light-field camera for obtaining an N-view image. The imaging apparatus 191 in FIG. 11 includes a sync signal generating unit 21, an optical system 201, an imaging unit 202, a video separating unit 203, an average signal computing unit 204, a difference signal computing unit 205-1 to a difference signal computing unit 205-(N−1), a coding unit 206, a signal transferring unit 28, a recording unit 29, and a display unit 31. Note that in FIG. 11 the same reference numerals are used as in FIG. 1 for corresponding portions and the description thereof is omitted as appropriate.

The optical system 201 can include a plurality of lenses, for example, and guides light incident from an object to the imaging unit 202. The imaging unit 202 generates a multi-view signal that contains signal components for N different views (3≦N)

by photoelectrically converting light incident from the optical system 201 in synchronization with a sync signal supplied from the sync signal generating unit 21 and supplies it to the video separating unit 203.

For example, of light from an object, a beam for a view to be incident on each pixel on the light sensing surface of the imaging unit 202 is previously determined. Light from an object is divided into beams for a plurality of views by a microlens array disposed in the optical system 201, and the beams are guided to the pixels of the imaging unit 202.

The video separating unit 203 separates a multi-view signal supplied from the imaging unit 202 into an image signal for each view on the basis of arrangement of pixels for views in the imaging unit 202 and supplies the image signals to the average signal computing unit 204 and the difference signal computing unit 205-1 to the difference signal computing unit 205-(N−1). Note that image signals for N views separated from a multi-view signal are referred to as image signal P1 to image signal PN, respectively.

The average signal computing unit 204 determines the average value of pixel values of pixels of an image signal P1 to an image signal PN supplied from the video separating unit 203 and sets the determined average value as the pixel value of a new pixel, thereby generating an average signal. Each pixel of an image corresponding to the average signal (hereinafter referred to as average image) is the average of pixels lying in the same location in images for N views.

The average signal computing unit 204 supplies a generated average signal to the display unit 31, the coding unit 206, and the difference signal computing unit 205-1 to the difference signal computing unit 205-(N−1).

The difference signal computing unit 205-1 generates a difference signal D1 by determining the difference between an image signal P1 supplied from the video separating unit 203 and an average signal supplied from the average signal computing unit 204. This process is repeated for all of the difference signal computing units 205-1 through 205-(N−1) to generate the difference signals D1 through D(N−1) by determining the difference between the image signals P1 through P(N−1). These generated difference signals D1 through D(N−1) are supplied to the coding unit 206.

Note that hereinafter the difference signal computing units 205-1 through 205-(N−1) are also referred to simply as the difference signal computing unit 205 if it is not necessary to distinguish between them. And, hereinafter the image signals P1 through PN are also referred to simply as the image signal P if it is not necessary to distinguish between them, and the difference signals D1 through D(N−1) are also referred to simply as the difference signal D if it is not necessary to distinguish between them.

The coding unit 206 includes an average signal coding unit 211 that codes an average signal from the average signal computing unit 204 and difference signal coding units 212-1 through 212-(N−1) that each codes the difference signal D from the difference signal computing unit 205. The coding unit 206 supplies the average signal and difference signal D acquired by coding to the recording unit 29 and the signal transferring unit 28.

Note that hereinafter the difference signal coding units 212-1 through 212-(N−1) are also referred to simply as the difference signal coding unit 212 if it is not necessary to distinguish between them.

### Description of Imaging Process

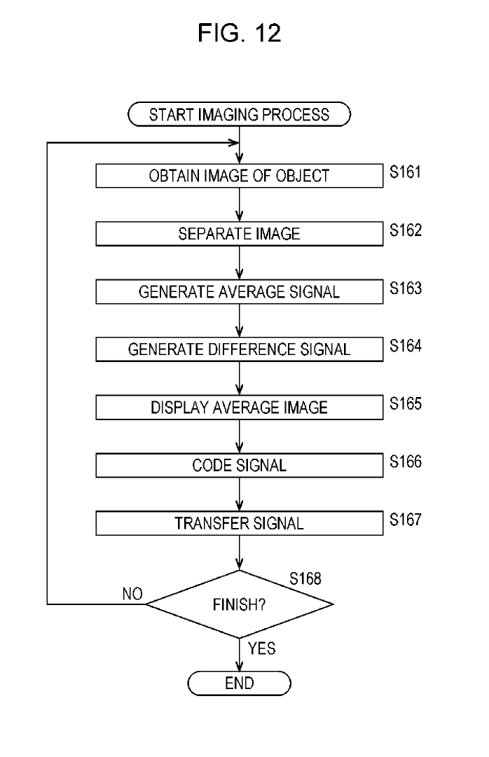

Incidentally, when a user operates the imaging apparatus 191 and provides an instruction to start obtaining a signal corresponding to an image of an object, the imaging apparatus 191 starts an imaging process, obtains the signal corresponding to the image of the object, and generates a multi-view signal. The imaging process performed by the imaging apparatus 191 is described below with reference to the flowchart of FIG. 12.

At step S161, the imaging unit 202 generates a signal corresponding to an image of an object. That is, the optical system 201 collects beams for views incident from an object and causes them to be incident on the imaging unit 202. The imaging unit 202 generates a multi-view signal corresponding to an image of an object by photoelectrically converting the beams incident from the optical system 201. Then, the imaging unit 202 supplies the multi-view signal to the video separating unit 203.

At step S162, the video separating unit 203 separates a multi-view signal supplied from the imaging unit 202 into an image signal P for each view and supplies them to the average signal computing unit 204 and the difference signal computing unit 205. Note that in the video separating unit 203 a correction process, such as gamma conversion, defect correction, or white balance adjustment, may be performed on an image signal P for each view.

At step S163, the average signal computing unit 204 generates an average signal by determining the average value of an image signal P1 to an image signal PN supplied from the video separating unit 203 and supplies it to the display unit 31, the average signal coding unit 211, and the difference signal computing unit 205. That is, the sum of image signals P is divided by the number N of views (the number of the image signals P) to generate an average signal.

At step S164, the difference signal computing unit 205 generates a difference signal

D by subtracting an average signal supplied from the average signal computing unit 204 from an image signal P supplied from the video separating unit 203 and supplies it to the difference signal coding unit 212. For examples, the difference signal computing unit 205-1 determines the difference between the image signal P1 and the average signal and thus generates the difference signal Dl.

At step S165, the display unit 31 displays an average image corresponding to an average signal supplied from the average signal computing unit 204. Because the average image is an image in which images of an object observed from views are overlaid with each other, a user can obtain an image while seeing the average image displayed on the display unit 31 and checking whether no error in the location of a congestion point occurs between the images for views. With this, the occurrence of an error in the location of a congestion point in a multi-view image can be suppressed more easily.

At step S166, the coding unit 206 codes an average signal from the average signal computing unit 204 and a difference signal D from the difference signal computing unit 205 and supplies them to the signal transferring unit 28 and the recording unit 29. That is, the average signal coding unit 211 codes the average signal, and the difference signal coding unit 212 codes the difference signal D.

At step S167, the signal transferring unit 28 transfers an average signal and a difference signal D supplied from the coding unit 206 to another apparatus. And, the recording unit 29 records an average signal and a difference signal D supplied from the coding unit 206.

At step S168, the imaging apparatus 191 determines whether acquisition of an image of an object is finished. For example, the imaging apparatus 191 may determine that image acquisition is finished, by receiving a user instruction.

At step S168, when it is determined that the process is not finished, the processing returns to step S161 and the above-described processing is repeated. In contrast to this, at step S168, when it is determined that the process is finished, the units of the imaging apparatus 191 stop their running processing, and the imaging process is complete.

In this manner, the imaging apparatus 191 generates an average signal from image signals P from acquired views, by obtaining a signal corresponding to an image of an object during obtaining the signal corresponding to the image of the object. The imaging apparatus then displays an average image. Thus, displaying an average image while generating signals corresponding to an image of an object, enables a user to more easily identify errors in the locations of a congestion points between images of various views, and to adjust focusing with high. As a result, the occurrence of a congestion point location error in a multi-view image can be suppressed.

Note that, although the imaging apparatus 191 is configured to acquire a multi-view signal that contains components for a plurality of views using the single optical system 201 and the single imaging unit 202, the optical system 201 and the imaging unit 202 may be provided for each view. In this case, because image signals P for N views are directly acquired by obtaining a signal corresponding to an image of an object, the video separating unit 203 is not necessary.

### Configuration of Signal Reproducing Apparatus

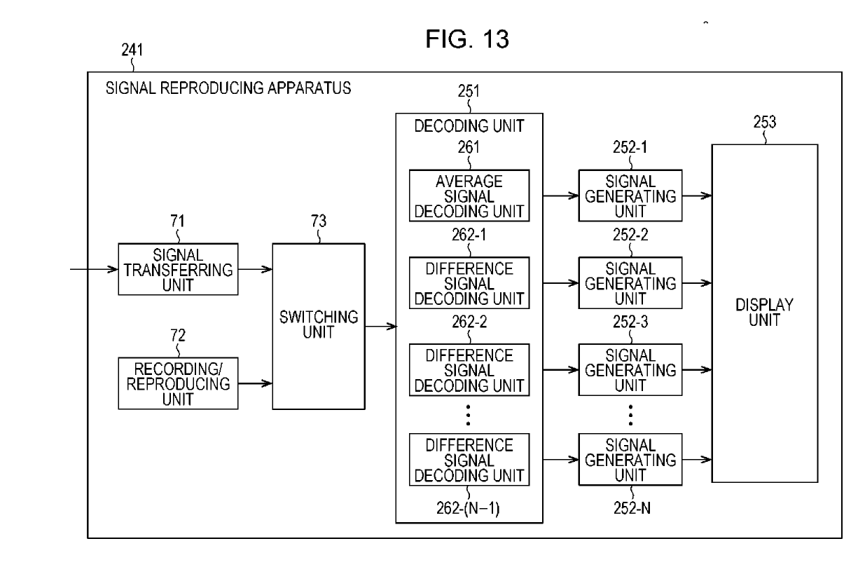

And, an average signal and a difference signal D output from the imaging apparatus 191 in FIG. 11 can be received and reproduced by a signal reproducing apparatus 241 illustrated in FIG. 13, for example.

The signal reproducing apparatus 241 illustrated in FIG. 13 includes a signal transferring unit 71, a recording/reproducing unit 72, a switching unit 73, a decoding unit 251, a signal generating unit 252-1 to a signal generating unit 252-N, and a display unit 253. Note that in FIG. 13 the same reference numerals are used as in FIG. 3 for corresponding portions and the description thereof is omitted as appropriate.

The decoding unit 251 includes an average signal decoding unit 261 that decodes an average signal from the switching unit 73 and difference signal decoding units 262-1 through 262-(N−1) that decode difference signals D1 through D(N−1) from the switching unit 73. The decoding unit 251 supplies the average signal and difference signals D through D(N−1) to the signal generating units 252-1 through 252-N.

Note that hereinafter the difference signal decoding units 262-1 through 262-(N−1) are also referred to simply as the difference signal decoding unit 262 if it is not necessary to distinguish between them.

The signal generating units 252-1 through 252-N generate image signals P for views from an average signal and difference signals D supplied from the decoding unit 251 and supply them to the display unit 253. Note that hereinafter the signal generating units 252-1 through 252-N are also referred to simply as the signal generating unit 252 if it is not necessary to distinguish between them.

The display unit 253 displays an N-view image corresponding to an image signal P for each view supplied from the signal generating unit 252. <Description of Reproducing Process

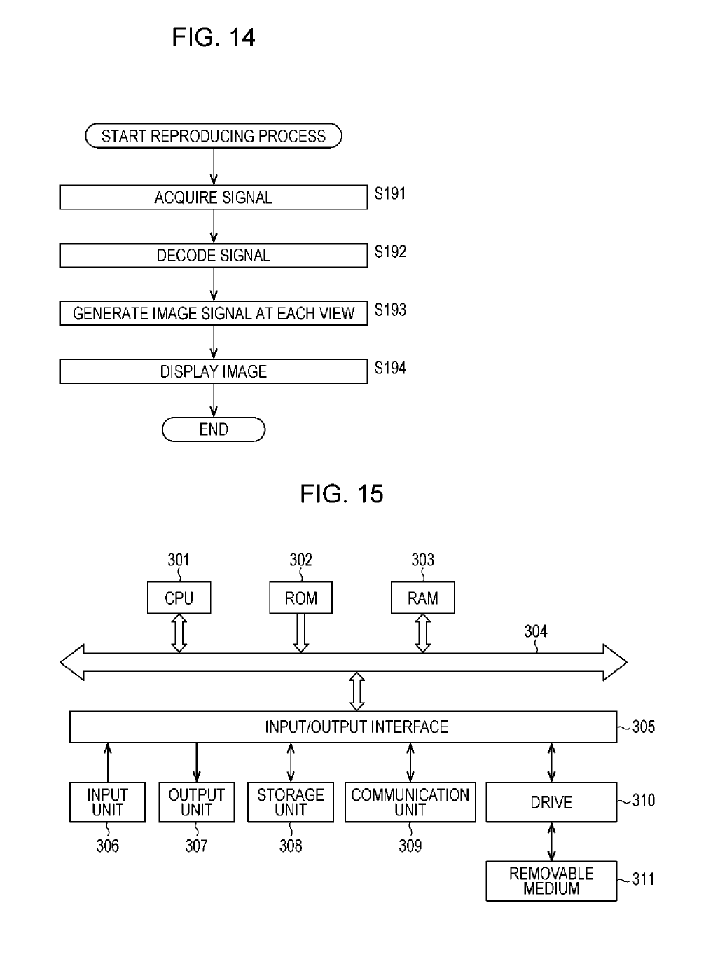

When being instructed by a user to display an N-view image, the signal reproducing apparatus 241 illustrated in FIG. 13 performs a reproducing process in response to the instruction and displays the N-view image. The reproducing process performed by the signal reproducing apparatus 241 is described below with reference to the flowchart of FIG. 14.

At step S191, the switching unit 73 acquires an N-view signal in response to a user command. That is, the switching unit 73 acquires a signal of a user-specified N-view image, that is, an average signal and a difference signal D from the signal transferring unit 71 and the recording/reproducing unit 72, and supplies them to the decoding unit 251.

At step S192, the decoding unit 251 decodes an average signal and a difference signal D supplied from the switching unit 73 and supplies them to the signal generating unit 252. Specifically, the average signal decoding unit 261 decodes an average signal, and the difference signal decoding unit 262 decodes a difference signal D.

At step S193, the signal generating unit 252 generates an image signal P for each view on the basis of an average signal and a difference signal D supplied from the decoding unit 251 and supplies them to the display unit 253.

For example, the signal generating unit 252-1 generates an image signal P1 by determining the sum of a difference signal D1 and an average signal. Similarly, the signal generating units 252-2 through 252-(N−1) generate image signals P2 through P(N−1) by determining the sums of a difference signals D2 through D(N−1) and an average signal. Additionally, the signal generating unit 252-N generates an image signal PN by subtracting the sum of the difference signals D1 through D(N−1) from the average signal.

At step S194, the display unit 253 employs a lenticular method or another method to display an N-view image corresponding to an image signals P1 through PN for views supplied from the signal generating unit 252, and the reproducing process finishes.

In this manner, the signal reproducing apparatus 241 decodes a coded average signal and difference signal, extracts an image signal for each view by computation, and displays an N-view image corresponding to the respective image signal.

And, all of the units in the above-described imaging apparatus 11, signal reproducing apparatus 61, signal reproducing unit 111, imaging apparatus 151, imaging apparatus 191, and signal reproducing apparatus 241 can be implemented using specialized hardware. In this manner, processes performed in these apparatus may be more easily performed in parallel.

The above-described series of processes may also be implemented by general-purpose processors executing software. If the series of processes is executed by software, a program forming the software is installed from a program storage medium into one or more processors incorporated in dedicated hardware or into a device that can perform various functions by installation of various kinds of programs, for example, a general-purpose personal computer.

FIG. 15 is a block diagram that illustrates a configuration example of hardware of a computer that executes the above-described series of processes using a program.

In the computer, a central processing unit (CPU) 301, a read-only memory (ROM) 302, and a random-access memory (RAM) 303 are connected to each other by a bus 304.

The bus 304 is connected to an input/output interface 305. The input/output interface 305 is connected to an input unit 306 including, for example, a keyboard, a mouse, and/or a microphone, an output unit 307 including, for example, a display and/or a speaker, a storage unit 308 including, for example, a hard disk and/or non-volatile memory, a communication unit 309 including, for example, a network interface, and a drive 310 for driving a removable medium 311, such as a magnetic disk, an optical disk, a magneto-optical disk, or semiconductor memory.

For the computer configured as described above, the above-described series of processes is performed by the CPU 301 loading a program stored in the storage unit 308 into the RAM 303 through the input/output interface 305 and the bus 304 and executing the program, for example.

A program executed by a computer (CPU 301) can be provided by being stored in the removable medium 311 being a package medium, such as a magnetic medium (including a flexible disk), an optical disk (e.g., compact-disk read-only memory (CD-ROM) or digital versatile disc (DVD)), a magneto-optical disk, or semiconductor memory, or through a wired or wireless transmission medium, such as a local area network, the Internet, or digital satellite broadcasting.

Then, a program can be installed into the storage unit 308 through the input/output interface 305 by attachment of the removable medium 311 to the drive 310. And, a program can be installed into the storage unit 308 by being received by the communication unit 309 through a wired or wireless transmission medium. In addition, a program can be stored in advance in the ROM 302 or the storage unit 308.

Note that a program executed by a computer may be a program by which processes are executed on a time-series basis in the order described in this specification or may also be a program by which processes are executed in parallel or at a necessary time, such as at the time of calling.

Note that embodiments are not limited to the foregoing embodiments, and various modifications can be made.

### REFERENCE SIGNS LIST

11 imaging apparatus 23-1, 23-2, 23 imaging unit 25 sum signal computing unit 26 difference signal computing unit 27 coding unit 30 signal switching unit 31 display unit 61 signal reproducing apparatus 74 decoding unit 76 L signal generating unit 77 R signal generating unit 78 display unit 161 optical system 162 imaging unit 163 video separating unit 191 imaging apparatus 201 optical system 202 imaging unit 203 video separating unit 204 average signal computing unit 205-1 to 205-(N−1), 205 difference signal computing unit 206 coding unit

1. A computer-implemented method for processing images on an electronic device, the method comprising:
receiving an image signal comprising a left-image signal representing a left image and a right-image signal representing a right image;
generating a sum signal for the image signal by combining the left-image signal and the right-image signal;
displaying a sum image corresponding to the sum signal, the displayed image including a convergence point and a focus point.

2. A method of claim 1, further comprising:
encoding the sum signal; and
outputting the encoded sum signal.

3. A method of claim 1, further comprising:
separating the received image signal into the left-image signal and the right-image signal.

4. A method of claim 3, further comprising:
performing a correction on the separated left-image signal and the separated right-image signal.

5. A method of claim 1, further comprising:
performing a gamma conversion on the left-image signal and the right-image signal.

6. A method of claim 1, wherein the sum signal represents an image comprising an overlay of the left image and the right image.

7. A method of claim 1, wherein the sum signal comprises a sum of pixel values for the left-image signal and the right-image signal when the pixels of the respective images are in a same location in a same frame.

8. A method of claim 1, wherein the sum signal comprises a normalization of a sum of pixel values for the left-image signal and the right-image signal when the pixels of the corresponding images are in a same location in a same frame.

9. A method of claim 1, further comprising:
generating a difference signal for the image signal by combining the left-image signal and the right-image signal;

10. A method of claim 2, wherein encoding the sum signal further comprises encoding a difference signal and outputting the encoded sum signal further comprises outputting the encoded difference signal.

11. A method of claim 9, further comprising:
displaying a difference image corresponding to the difference signal.

12. A method of claim 9, wherein the difference signal comprises a difference of pixel values for the left-image signal and the right-image signal when the pixels of the respective images are in a same location in a same frame.

13. A method of claim 9, wherein the difference signal comprises a normalization of a difference of pixel values for the left-image signal and the right-image signal when the pixels of the corresponding images are in a same location in a same frame.

14. An electronic device for processing images, the device comprising:
an imaging unit configured to receive an image signal comprising a left-image signal and a right-image signal;
a signal computing unit configured to generate a sum signal for the image signal by combining the left-image signal and the right-image signal; and
a display unit configured to display a sum image corresponding to the sum signal, the displayed image including a convergence point and a focus point.

15. A tangibly embodied non-transitory computer-readable storage medium including instructions that, when executed by a processor, perform a method for processing images, the method comprising:
receiving an image signal comprising a left-image signal representing a left image and a right-image signal representing a right image;
generating a sum signal for the image signal by combining the left-image signal and the right-image signal;
displaying a sum image corresponding to the sum signal, the displayed image including a convergence point and a focus point.
